(19) United States
(12) Patent Application Publication
(10) Pub. No.: US 2002/0049036 A1
(43) Pub. Date: Apr. 25, 2002

(54) WIRELESS PHONE/DATA JACK USING 49 MHZ RF TECHNOLOGY

(76) Inventors: SCOTT R. BULLOCK, SOUTH JORDAN, UT (US); DAVID W. THORSON, SALT LAKE CITY, UT (US)

Correspondence Address: Lloyd W Sadler or Daniel P McCarthy, Parsons Behle & Latimer, 201 South Main Street, Suite 1800, Salt Lake City, UT, 84111-2218, US

(21) Appl. No.: 09/418,371

(22) Filed: Oct. 13, 1999

(51) Int. Cl. H04Q 7/20

(52) U.S. Cl. 455/3.05; 455/462; 455/557; 370/328

(57) ABSTRACT

A wireless telephone jack that uses the 49 MHz frequency band as allowed by the FCC (47 CFR 15.233). This jack supports both voice and data communication and operates as a convenient means for providing telephone device communications in locations where telephone wiring is limited or unavailable. A base station is provided to connect to the telephone lines, or a central office, which has an RF transmitter and receiver for communicating with a provided extension unit, which also has an RF transmitter and receiver for communicating with the base station. This invention is designed to work with standard telephone communication signals and standard telephone equipment.

### BACKGROUND OF THE INVENTION

1. Field of the Invention

This invention relates to wireless telephone/data communication systems. More specifically, this invention relates to wireless communication between a central office and extension units using the 49 MHz band.

2. Description of Related Art

A variety of wireless communication systems and devices have been proposed and are widely used. Traditionally, these devices and systems have not accommodated both voice signals and data signals in the 49 MHz band for wireless communications. For general background material, the reader is directed to the following U.S. Patent documents, each of which is hereby incorporated by reference in its entirety for the material contained therein.

U.S. Pat. No. 4,462,113 describes a cordless transmitting and receiving apparatus, which is capable of providing transmitting and receiving between a key transmitting and receiving apparatus such as a telephone and a portable remote transmitting and receiving apparatus.

U.S. Pat. No. 4,467,140 describes a cordless telephone system, which includes a base unit operatively coupled to a user's telephone lines and a relatively compact portable cordless handset.

U.S. Pat. Nos. 4,468,538, 4,468,539, 4,468,540, 4,469,918, 4,471,166, 4,471,167, and 4,471,168 describe a wireless extension telephone system, that includes a base unit connected to a telephone line and a remote extension unit.

U.S. Pat. No. 4,471,493 describes a remote unit for use in a wireless extension telephone system having a self-contained dipole antenna.

U.S. Pat. No. 4,685,099 describes a method and apparatus for a duplex communication system wherein a local station transmits a modulated signal at a nominal fixed frequency to a remote station.

U.S. Pat. No. 4,688,257 describes an apparatus and method for synchronizing the operation of the frequency sensitive devices of two or more transceiver units in a secure, wireless communication system.

U.S. Pat. No. 4,706,274 describes a cordless telephone system that includes a control unit having a speaker, a microphone and control circuitry for selective operation in a “normal” mode for communications between the handset and an outside party.

U.S. Pat. No. 5,115,463 describes an extended cordless telephone system for communicating information signals from a plurality of telephone lines through a telephone exchange, including a central station and a plurality of remote units.

U.S. Pat. No. 5,201,066 describes a radio-telephone system employing a manner of changing a channel and a privacy digital code and interspersing them between by wireless and a method of changing the privacy digital code.

U.S. Pat. No. 5,239,682 describes a call hand-over technique, that uses channel information from both the target base station and subscriber terminal in determining which radio traffic channel will be used.

U.S. Pat. No. 5,265,150 describes a wireless PBX system that provides installation ease without site engineering or trial-and-error placement of components within the system.

U.S. Pat. Nos. 5,276,908 and 5,345,597 describe a call set-up technique that is characterized by the use of channel information from both base station and subscriber terminal in determining the radio traffic channels upon which to set-up a new call.

U.S. Pat. No. 5,297,203 describes a digital cordless telephone apparatus, that comprises a microprocessor based battery powered portable hand-set unit and a microprocessor based stationary base unit which each transmit and receive digital voice data and digital command data to and from one another over multiple RF channel frequencies in the 902-928 MHz band.

U.S. Pat. Nos. 5,406,615 and 5,574,775 describe a universal wireless radiotelephone communication apparatus that includes a first base station having a wide area of coverage, transmitting radiotelephone signals at a first band of frequencies and a second base station having a localized area of coverage, transmitting radiotelephone signals at a second band of frequencies higher than said first band of frequencies.

U.S. Pat. Nos. 5,428,668, 5,526,402, and 5,535,259 describe a communications system where transceiver frequency and optionally power level are allocated to a radio personal communications system, which includes a base station connected to a wire telephone network and a cellular terminal operating within a region of a wide area cellular network.

U.S. Pat. No. 5,446,759 describes a system and method for transmission of information subject to fading by using a RF carrier modulated with a sub-carrier modulated with the information.

U.S. Pat. No. 5,479,479 describes a cellular telephone that is interconnected to a control unit via a cable. The cable contains both appropriate interdisciplinary connections for attachment to the telephone at one end and to the control unit at the other end via a universal connector.

U.S. Pat. No. 5,504,803 describes a personal communications system that permits a wireless handset to access either a cellular mobile telephone system or a private wireless telephone system.

U.S. Pat. No. 5,550,895 describes a bimodal portable telephone that provides cellular service and improved cordless service in a common handset.

U.S. Pat. No. 5,592,480 describes a wireless communication system base station making use of a wideband, multi-channel digital transceiver having incorporated therein a time division multiple access bus.

U.S. Pat. No. 5,623,495 describes a portable base station-switching device for use in a wireless ATM local area network.

U.S. Pat. No. 5,657,325 describes an improved wireless transmitter and method for transmitting incremental redundancy.

U.S. Pat. No. 5,657,358 describes a toll quality terrestrial wireless digital multiple access terrestrial communication system having a base station in communication with telephone lines and with mobile subscriber stations.

U.S. Pat. No. 5,661,802 describes a telephone and auxiliary power distribution system in a building that has a flexible multi-conductor signal and power distribution cable.

U.S. Pat. No. 5,666,398 describes a radio telephone system that is designed to meet the basic telecommunication needs of areas, which are insufficiently or not yet covered.

U.S. Pat. No. 5,677,927 describes an impulse radio communications system that uses one or more subcarriers to communicate information from an impulse radio transmitter to an impulse radio receiver.

U.S. Pat. No. 5,678,202 describes an antenna system and method for use in a portable unit of a wireless telephone headset, wireless telephone headset adapter, or other telecommunication device.

U.S. Pat. No. 5,687,194 describes a system for the wireless transmission of multiple information signals that utilizes digital time division circuits between a base station and a plurality of subscriber stations.

U.S. Pat. No. 5,710,798 describes a system and method for wireless transmission of information, which is subject to fading by using a RF carrier modulated with a subcarrier modulated with the information.

U.S. Pat. No. 5,715,516 describes a cellular communications system that includes forward channel communications to users and corresponding reverse channel communications from mobile users.

U.S. Pat. No. 5,717,737 describes an apparatus and method is provided for transparent communication between a wireless remote or mobile device and a fixed wired communication host network.

U.S. Pat. No. 5,734,678 describes a terrestrial RF telephone system that provides a plurality of voice signal channels on a plurality of forward direction carrier frequencies.

U.S. Pat. No. 5,745,532 describes a system and method for wireless transmission of information which is subject to fading by using a RF carrier modulated with a subcarrier modulated with the information.

U.S. Pat. No. 5,751,773 describes a system for wireless serial transmission of encoded information which are subject to fading that causes erroneous uncorrectable bit errors.

U.S. Pat. No. 5,761,621 describes a network and method of operating a network of wireless service providers that is adapted to interact with a plurality of omni-modal wireless products within a given geographic area in a manner to permit the wireless service providers to “borrow” radio frequencies from other wireless service providers within the same geographic region.

U.S. Pat. No. 5,784,402 describes a binary and quadrature Feher's modulation transmitter-receiver system and circuit.

U.S. Pat. No. 5,805,667 describes an apparatus for, and method of, range-testing a cordless communication device.

U.S. Pat. No. 5,812,539 describes a method and apparatus of communicating information using Time Division Multiple Access and adaptive transmission and reception.

U.S. Pat. No. 5,835,863 describes a wireless telephone set that performs digital communication and that employs light-emitting diodes for illumination.

U.S. Pat. No. 5,844,596 describes a system that provides video signal communication between a source of the video signal and a plurality of units that include destinations of the video signal.

U.S. Pat. No. 5,845,203 describes a method for seamlessly transmitting application specific messages over cellular radio system control channels and switches.

U.S. Pat. No. 5,852,604 describes a power-conserving time division multiple access radiotelephone system.

U.S. Pat. No. 5,854,985 describes a frequency and protocol agile wireless communication produce and chipset for forming the same.

U.S. Pat. No. 5,890,055 describes a wireless communications system that includes a number of clusters of repeaters wherein all repeaters within a cluster are connected to a common hub via respective millimeter-wave radio links.

U.S. Pat. No. 5,896,569 describes a system and method for providing wireless access to a telephone line of a telephone network that uses a mobile terminal and a crossconnect base station.

U.S. Pat. No. 5,901,246 describes an adaptive interface for a programmable system, for predicting a desired user function.

U.S. Pat. No. 5,909,491 describes a method for sending a secure message in a telecommunications system using public encryption keys.

U.S. Pat. No. 5,913,163 describes an integrated local communication system that comprises a plurality of locally-positioned communication devices, at least one of which locally-positioned communication devices is operably coupled to a local interface module.

U.S. Pat. No. 5,915,021 describes a method for sending a secure message in a telecommunications system that uses public encryption keys.

U.S. Pat. No. 5,915,207 describes a device for implementing a multimedia communication dissemination system.

U.S. Pat. No. 5,920,821 describes an analog cellular voice telephone system and subscriber stations that are controlled to conserve power and to provide alternate service carriers.

U.S. Pat. No. 5,930,719 describes a cordless system that comprises a laptop computer with a modem connected to a modem data port on a cordless telephone handset.

U.S. Pat. No. 5,930,728 describes a communication system for wireless dual purpose phone that is operable at 1900 megahertz in the PCS system that includes a plurality of transceiver wherein at least three communication links are formed.

U.S. Pat. No. 5,930,729 describes an accessory apparatus for mobile radio telephones, particularly those used in cellular networks and that permits utilization of the full communication range capable of a vehicle-mounted cellular radio telephone by a cordless portable handset remote from the vehicle.

### SUMMARY OF THE INVENTION

It is desirable to provide a wireless telephone/data jack that provides the means for connecting multiple telephones, fax machines, modems and the like without requiring the use of telephone wires. In particular, it is desirable to provide a telephone/data communication system that communicates between the base station and extension units in one frequency band and communicates between the extension units and the base station using a second frequency band.

Therefore, it is the general object of this invention to provide a wireless telephone/data jack that communicates between a base station and one or more extension units using the 49 MHz band.

It is a further object of this invention to provide a wireless telephone/data jack that supports both voice and data communication.

Another object of this invention is to provide a wireless telephone/data jack that provides a convenient means for adding a telephone line to a location without requiring additional telephone wiring.

A further object of this invention is to provide a wireless telephone/data jack that provides a base station that is connected to an existing telephone jack.

A still further object of this invention is to provide a wireless telephone/data jack that permits extension units to be placed anywhere within the transmission range of the base unit and which can be connected communication devices, such as modems, telephones, set-top boxes, fax machines and the like.

These and other objects of this invention are achieved by the system described herein and will be readily apparent to those of ordinary skill in the art upon a review of the following drawings, detailed description and claims.

### BRIEF DESCRIPTION OF THE DRAWINGS

FIG. 1 is a block diagram of the preferred wireless data and telephone connection system of this invention.

FIG. 2 is a block diagram of the preferred modulator and demodulator scheme for data of the preferred embodiment of this invention.

FIG. 3 is a detailed block diagram of the preferred components of the base station.

FIG. 4 is a detailed block diagram of the preferred components of the extension unit.

### DETAILED DESCRIPTION OF THE INVENTION

This invention is a wireless telephone/data jack, which provides the means for connecting multiple telephones, fax machines, modems, and other telecommunications devices without the use of dedicated telephone wires. As new communication devices become available, the need for additional communication channels has become more acute. This is particularly true for communication users who are limited by the telephone wiring in their building or structure. This invention addresses the need for additional communication links, by providing a wireless connection between a central office to one or more extension units, where a standard telephone, modem, fax machine and the like can be connected. In particular, this invention makes use of the 49 MHz frequency band for RF communication between the central office/base station and the extension units. This jack supports both voice and data communication. The system of this invention includes a base station and one or more extension units. The base station is typically connected to the central office using an existing standard telephone jack, while the extension units are positioned within transmission range of the base station and are connected to the desired telephone communication device (telephone, modem, set top box, fax machine and the like). Both the base station and the extension units have a transmitter and a receiver.

Typically and preferably, this invention employs an RF link that uses two different frequencies in the 49 MHz band, one for a transmission channel between from the base station to the extension unit, and one for the transmission path from the extension unit to the base station.

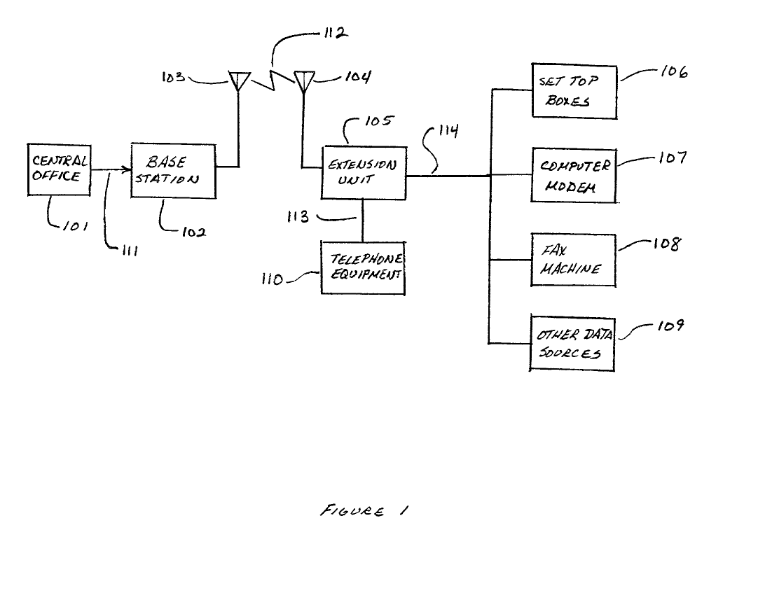

In FIG. 1 the base station 102 is shown connected 111 to the central office 101 and provides the interface to the central office 101. Information signals received from the central office 101 are frequency modulated, preferably on to a carrier frequency of 46.73 MHz. This signal is then amplified, filtered and transmitted 112 from the transmitting antenna 103.

The extension unit 105 receives the signal from the base station 102 via the extension unit antenna 104. The extension unit 105 FM demodulates the carrier signal and sends the received data on the set top box 106, computer modem 107, fax machine 108, and/or other data communication devices 109.

The extension unit 105 is electrically connected 114 to receive data from the set top box 106, computer modem 107, fax machine 108, and/or other data communication devices 109. The extension unit 105 can also receive voice telephone signals from telephone equipment 110. The extension unit 105 frequency modulates a carrier with the received signals and transmits the data 112 to the base station 102 by the extension transmitter 404 , preferably at the frequency of 49.875 MHz to prevent cross-talk between the extension unit 105 transmitting frequency and the base station 102 transmitting frequency. Extension signals, including the signals from the set top boxes 106, computer modem 107, fax machine 108 and other data sources 109, are amplified, filtered and transmitted from the extension antenna 104 and are received by the base station 102, where the signal is FM demodulated and the data is forwarded to the central office 101, via the central office interface circuitry 101.

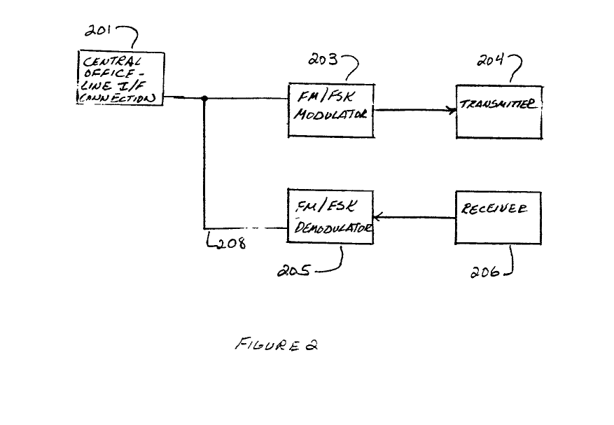

FIG. 2 shows the modulation and demodulation schemes used in this invention in both the base station 102 and the extension unit 105. The central office/line interface connection 201. The central office/line interface connection 201 uses an FM modulation. An FM/FSK modulator 203 is provided to perform this modulation. The resulting modulated signal is transmitted using an RF transmitter 204. Signals received from the receiver 206 are sent to the FM/FSK demodulator 205, where the signals are detected and split into two paths 207, 208; the central office/line interface connection signal 207.

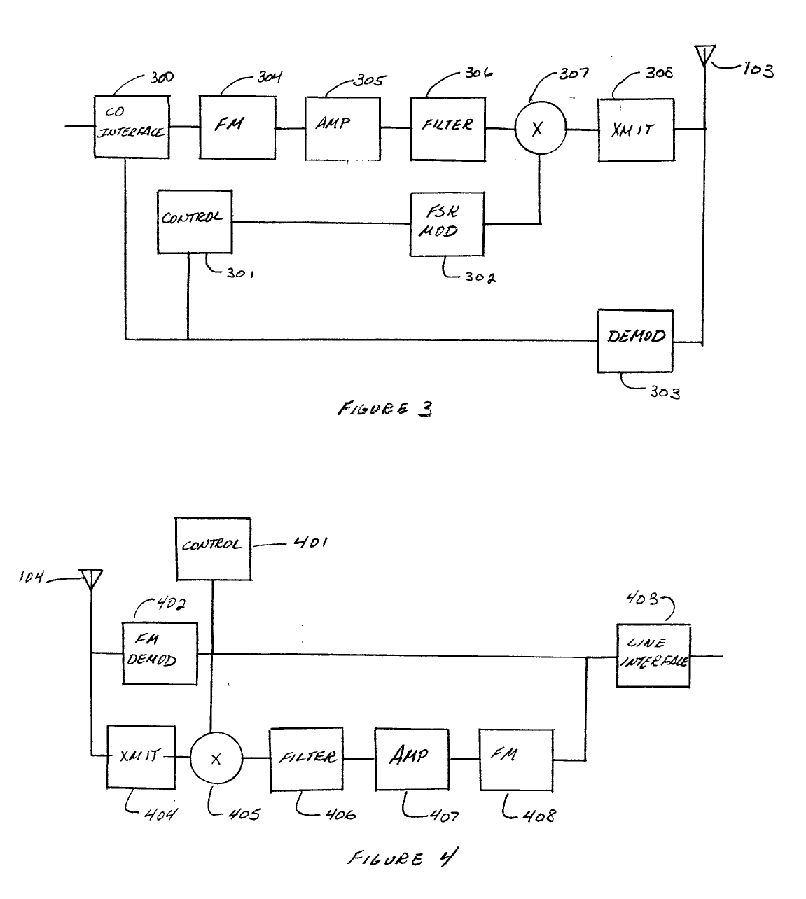

FIG. 3 shows the detailed block diagram of the preferred components of the base station 102. The preferred base station 102 has a central office interface 300, which provides the electronic communication interface between the central office 101 and the base station 102. Received signals are frequency modulated by an FM modulator 304. The FM modulated signals are sent to an amplifier 305, which amplifies the signal and electrically communicates the signal to a filter 306. The output of the filter 306 passes through a mixer 307 to the base transmitter 305, which in turn transmits the signal to the base antenna 103. Signals received by the base station 102 from the extension unit 105 are received by the base antenna 103, demodulated by the demodulator 303, which in turn is transmitted to the central office interface 300. The modulated FSK signal is mixed 307 and transmitted 305 to the extension unit 105 via the base antenna 103.

FIG. 4 shows the detailed block diagram of the preferred components of the extension unit 105. Signals received from the base station 102 come to the extension unit 105 via the extension antenna 104, where the received signals are demodulated by the FM demodulator 402. The received signals are communicated to the set top boxes 106, computer modem 107, fax machine, and/or other data communication devices 109, via the line interface. Signals received from the set top boxes 106, computer modem, 107, fax machine, and/or other data communication devices 109 are FM modulated by the FM modulator 408, which passes the signal to the amplifier 407. The output of the amplifier 407 is connected to a filter 406, which in turn passes the signal through a mixer 405 to the extension transmitter 404 for communication to the base station 102 via the extension antenna 104.

The described embodiment of this invention is to be considered in all respects only as illustrative and not as restrictive. Although the embodiment described in detail here, includes certain specific components and connections, the invention is not limited thereto. The scope of this invention is, therefore, indicated by the appended claims rather than by the foregoing description. All changes and alternatives, which come within the meaning and range of equivalency of the claims are to be considered as embraced as within their scope.

We claim:

1. A wireless telephone jack, comprising:
(A) a base station, connected to central office telephone equipment source;
(B) an extension unit, connected to a telephone device; and
(C) a communication channel communicating between said base station and said extension unit.

2. A wireless telephone jack, as recited in claim 1, wherein said communication channel uses a 49 MHz frequency band.

3. A wireless telephone jack, as recited in claim 1, wherein said central office telephone equipment source further comprises a standard RJ-11 telephone connection.

4. A wireless telephone jack, as recited in claim 1, wherein said base station further comprises a central office line interface circuit electrically connected to said central office source.

5. A wireless telephone jack, as recited in claim 4, wherein said base station further comprises a base controller electrically connected to said central office line interface circuit.

6. A wireless telephone jack, as recited in claim 4, wherein said base station further comprises a base transmitter electrically connected to said central office line interface circuit.

7. A wireless telephone jack, as recited in claim 6, wherein said base station further comprises a base transmit antenna electrically connected to said base transmitter.

8. A wireless telephone jack, as recited in claim 4, wherein said base station further comprises a base receiver electrically connected to said central office line interface circuit.

9. A wireless telephone jack, as recited in claim 8, wherein said base station further comprises a base receiver antenna electrically connected to said base receiver.

10. A wireless telephone jack, as recited in claim 1, wherein said telephone device is selected from the group consisting of a telephone receiver, a modem, a set top box, and a fax machine.

11. A wireless telephone jack, as recited in claim 1, wherein said extension unit further comprises a line interface circuit electrically connected to said telephone device.

12. A wireless telephone jack, as recited in claim 11, wherein said extension unit further comprises an extension controller electrically connected to said line interface circuit.

13. A wireless telephone jack, as recited in claim 11 wherein said extension unit further comprises an extension transmitter electrically connected to said subscriber line interface circuit.

14. A wireless telephone jack, as recited in claim 13, wherein said extension unit further comprises an extension transmitter antenna electrically connected to said extension transmitter.

15. A wireless telephone jack, as recited in claim 11, wherein said extension unit further comprises an extension demodulator electrically connected to said line interface circuit.

16. A wireless telephone jack, as recited in claim 15, wherein said extension unit further comprises an extension receiver antenna electrically connected to said extension demodulator.

17. A wireless telephone jack, comprising:
(A) a base station, having a base transmitter and a base demodulator;
(B) an extension unit, having an extension transmitter and an extension demodulator; and
(C) a communication link using the an RF frequency band of approximately 49 MHz.

18. A wireless telephone jack, as recited in claim 17, wherein said base transmitter transmits at a frequency of approximately 49 MHz.

19. A wireless telephone jack, as recited in claim 17, wherein said extension transmitter transmits at a frequency of approximately 49 MHz.

20. A wireless telephone jack, comprising:
(A) a base station;
(B) an extension unit; and
(C) a communication channel providing signal communication between said base station and said extension unit.
